(19) United States
(12) Patent Application Publication
(10) Pub. No.: US 2022/0393281 A1
(43) Pub. Date: Dec. 8, 2022

(54) Self-balancing floating battery case

(71) Applicants: Xinfeng Liao, Zhejiang Province (CN); Xiaohuan Xia, Zhejiang Province (CN)

(72) Inventors: Xinfeng Liao, Zhejiang Province (CN); Xiaohuan Xia, Zhejiang Province (CN)

(21) Appl. No.: 17/585,730

(22) Filed: Jan. 27, 2022

(30) Foreign Application Priority Data
Jun. 2, 2021 (CN) 2021212158806

(51) Int. Cl. H01M 50/24; H01M 50/262; H01M 50/244; H01M 50/287; H01M 50/291; F21V 23/02; F21L 4/08

(52) U.S. Cl. CPC H01M 50/24; H01M 50/262; H01M 50/244; H01M 50/287; H01M 50/291; F21V 23/023; F21L 4/08; F21W 2131/10

(57) ABSTRACT

A self-balancing floating battery case, comprising an upper casing and a lower casing, wherein the upper casing and the lower casing are connected by threads, a height of the upper casing is bigger than a height of the upper casing. A light opening is provided at an intermediate portion of the upper casing away from a center of the upper casing, a box surrounding the light opening is provided on an inner wall of the upper casing, the box is divided to be a PCB cavity and a battery cavity, a main body of the light opening deviates towards the PCB cavity and a main body of the battery cavity deviate towards the center of the upper casing. In the present invention, existing structures are modified, the battery case has a higher waterline, entrance of water can be prevented; and eccentricity of the center of gravity is corrected by weight.

### TECHNICAL FIELD

The present invention relates to the technical field of battery cases and more specifically, a self-balancing floating battery case.

### BACKGROUND TECHNOLOGY

With rapid development of economy and the society, people's living standards rise gradually; a ratio of spiritual and cultural consumption is also increasing, there are more and more natural and artificial scenic spots for travelling and visiting everywhere, a lot of decorations are used in these scenic spots, and floating decorations, as attractions on rivers and lakes in the scenic sites, appear.

There are many kinds of floating decorations, such as lotus lanterns, wherein an artificial lotus is provided above a battery case, which serves as a seat, one or more LED lights protrude from the battery case and are implanted in the artificial lotus, lighted and floating on water by buoyancy of the battery case, so that a glowing lotus floating on water is presented.

However, at present, most of the battery cases comprise an upper casing and a lower casing, and a connection part between the upper casing and the lower casing is located at a central line of the battery case in a longitudinal direction, whereas the battery case, upon bearing weight of at least one battery and the artificial lotus lantern, tends to subside, and the lower casing is liable to be submerged underwater, therefore, water can enter the battery case, and the entire lotus lantern can only be abandoned. Furthermore, due to restriction of established design concepts, designers usually open slots for LED lights at the very center of the upper casing, while the LED lights are connected to the PCU board, the batteries can only be placed to either side, and in this way, the batteries of higher weight move a center of gravity of the entire battery case from the center to either side, as a consequence, the lotus lantern is either floating twistedly on water, which affects appearance of the scenery; or overturned, so that the lotus lantern is immersed in water and can no longer be used. Therefore, there are deficiencies with design of the floating battery cases currently available, and a correction is required.

### SUMMARY OF THE INVENTION

A purpose of the present invention is to overcome deficiencies of the prior art, and provide a self-balancing floating battery case, wherein existing structures are slightly modified, so that a waterline of the battery case is higher, and entrance of water can be prevented; furthermore mass eccentricity is corrected by weight, so that the center of gravity falls on a central line of the battery case, overturning can be prevented, and a floating position of the battery case can be just, and ornamental properties of the battery case can be higher.

To realize the foregoing purpose, the present invention provides the following technical solution: a self-balancing floating battery case, comprising an upper casing and a lower casing, wherein the upper casing and the lower casing are connected by threads and a height of the lower casing is higher than a height of the upper casing.

In the present invention, a connection joint between the upper casing and the lower casing is moved to a higher position, so that a waterline of the battery case is higher, and entrance of water can be prevented.

Preferably, a ratio between the height of the upper casing and the height of the lower casing falls into a range of 1:2 to 1:4. That is to say, the height of the lower casing occupies an interval of two thirds to four fifths of a longitudinal height of the battery case, wherein two thirds and four fifths of the longitudinal height of the battery case are included and optimum.

Preferably, a sealing ring is provided between the upper casing and the lower casing. With the sealing ring, no water can enter from a joint of the upper casing and the lower casing, which makes the entire battery case more reliable.

Preferably, a light opening is eccentrically provided in an intermediate portion of the upper casing, a box surrounding the light opening is provided at an inner wall of the upper casing, wherein the box is divided into a PCB cavity and a battery cavity, a main body of the light opening inclines towards the PCB cavity while a main body of the battery cavity inclines towards a center of the upper casing.

A weight of a PCB board provided in the PCB cavity is lighter than a weight of a battery provided in the battery cavity, so that a center of gravity of the battery case deviates from a center of the battery case, so a floating position of the battery case is not just, and there is a risk of overturning, therefore, in the present invention, by inclining the main body of the battery cavity to a center of the upper casing, the PCB board and the battery are balanced, and the center of gravity is maintained in the center of the entire battery case, so that the battery case is floating justly and stably.

Preferably, a cap is provided on an outlet at a lower end portion of the box. With the cap the battery and the PCB board can be supported, so that the battery case is more stable during floating and swaying.

Preferably, an independent light cover is provided in the light opening, wherein the light cover is connected to the light opening by sealing by glues.

As it is necessary for the light cover to have good light transmission properties, die sinking of the lantern cover shall be done separately, with a material different from a material used for making the upper casing, and when the light cover is a separate part, sealing performance shall be promised to prevent entrance of water.

Preferably, a cableway is provided beside the light opening in the upper casing, wherein the cableway corresponds to the PCB cavity, a PCT board is provided in the PCB cavity, a storage battery is provided in the battery cavity, a cable is introduced from the PCB board and the cable passes the cableway and is connected with at least one solar energy charger board.

As usage and floating time of the battery case is long, energy stored in the storage battery is limited, by providing the solar energy charger board the storage battery can be charged so that life of the battery case can be longer.

Preferably, the at least one solar energy charger board are provided to be two.

The two solar energy charger boards can be provided symmetrically on both sides of the upper casing, so as to maintain balance thereof and more energy can be provided and charging can be quicker.

Beneficial effects: in the present invention, by slightly modifying the existing structures, the battery case has a higher waterline, so entrance of water can be prevented; eccentricity of the center of gravity can be prevented by weight, so that the center of gravity is maintained on the central line of the battery case, overturning can be prevented, a floating position of the battery case is just, and ornamental properties of the battery case can be higher.

### BRIEF DESCRIPTION OF DRAWINGS

FIG. 1 is a structural diagram showing the present invention;

FIG. 2 is an exploded structural diagram showing the present invention;

FIG. 3 is a structural diagram showing the upper casing of the present invention; and

FIG. 4 is a bottom view of the upper casing in FIG. 3.

In the drawings: 1—lower casing; 2—upper casing; 3—sealing ring; 4—light opening; S—light cover; 6—box; 7—PCB cavity; 8—battery cavity; 9—cableway; and 10—cap.

### EMBODIMENTS

To help understanding of technical solutions, features and purposes of the present invention and show them more clearly, hereinafter the present invention will be described in conjunction with specific embodiments.

### Embodiment 1

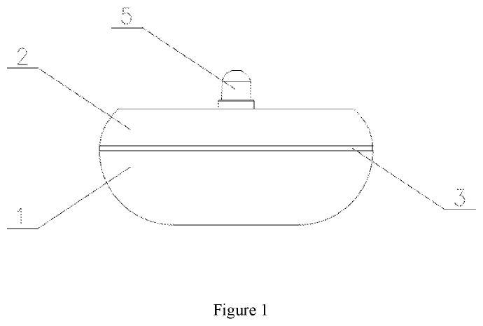

As shown in FIG. 1, a self-balancing floating battery case, comprising an upper casing 2 and a lower casing 1, wherein the upper casing 2 and the lower casing 1 are connected by threads, and a height of the lower casing 1 is bigger than a height of the upper casing 2. A sealing ring 3 is provided between the upper casing 2 and the lower casing 1.

A ratio between the height of the upper casing 2 and the height of the lower casing 1 falls in a range of 1:2 to 1:4.

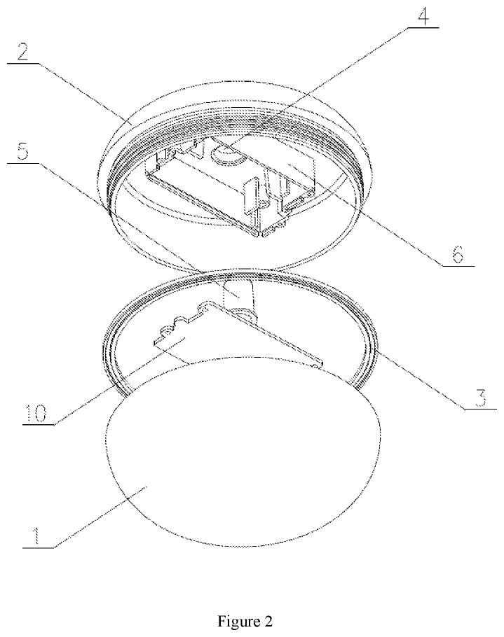

As shown in FIG. 2, a light opening 4 is provided at an intermediate portion of the upper casing 2, a light cover 5 is inserted in the light opening 4 and the light cover 5 is connected in the light opening 4 by sealing by glues.

A box 6 surrounding the light opening 4 is provided on an inner wall of the upper casing 2, wherein a cap 10 is provided at an outlet at a lower end portion of the box 6.

The box 6 is divided to be a PCB cavity 7 and a battery cavity 8, wherein a PCB board is provided in the PCB cavity 7 and a storage battery is provided in the battery cavity 8.

### Embodiment 2

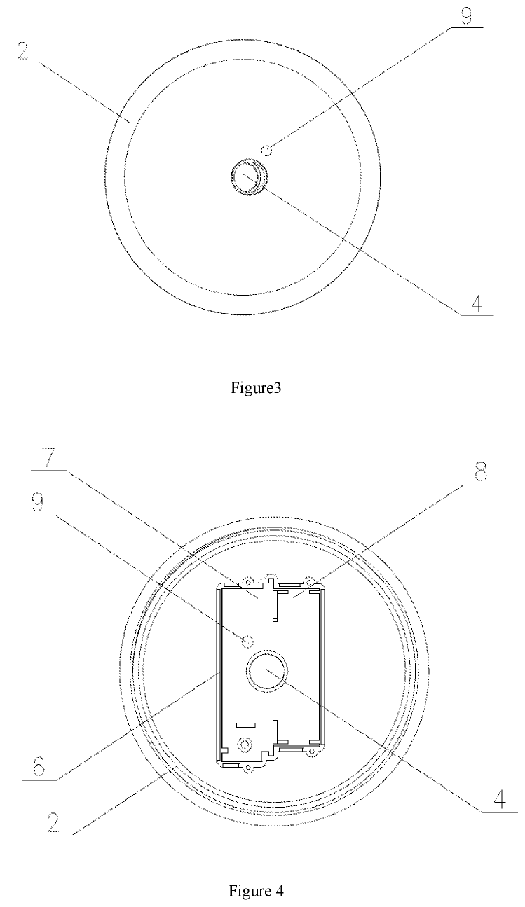

As shown in FIG. 3 and FIG. 4, a light opening 4 is provided at an intermediate portion of the upper casing 2 away from a center of the upper casing 2, a main body of the light opening 4 inclines towards the PCB cavity 7, and consequently, a main body of the battery cavity 8 inclines towards the center of the upper casing 2.

Other features are the same as those in embodiment 1.

### Embodiment 3

A cableway 9 is provided beside the light opening 4 in the upper casing 2, wherein the cableway 9 is provided in the PCB cavity 7, a cable is introduced from the PCB board and the cable is connected with a pair of solar energy charger boards after passing through the cableway 9.

Other features are the same as those in embodiment 2.

Use of the battery case: in the present invention, the existing structures are slightly modified so that the battery case has a higher waterline, and entrance of water can be prevented; and eccentricity of the center of gravity is corrected by weight, so that the center of gravity is maintained on the central line of the battery case, overturning can be prevented, a floating position of the battery case is just and ornamental properties of the battery case can be higher.

We claim:

1. A self-balancing floating battery case, comprising an upper casing and a lower casing, wherein the upper casing and the lower casing are connected by threads and a height of the lower casing is higher than a height of the upper casing.

2. The self-balancing floating battery case according to claim 1, wherein a ratio between the height of the upper casing and the height of the lower casing falls into a range of 1:2 to 1:4.

3. The self-balancing floating battery case according to claim 1, wherein a sealing ring is provided between the upper casing and the lower casing.

4. The self-balancing floating battery case according to claim 1, wherein a light opening is eccentrically provided in an intermediate portion of the upper casing, a box surrounding the light opening is provided at an inner wall of the upper casing, wherein the box is divided into a PCB cavity and a battery cavity, a main body of the light opening inclines towards the PCB cavity while a main body of the battery cavity inclines towards a center of the upper casing.

5. The self-balancing floating battery case according to claim 1, wherein a cap is provided on an outlet at a lower end portion of the box.

6. The self-balancing floating battery case according to claim 1, wherein an independent light cover is provided in the light opening, wherein the light cover is connected to the light opening by sealing by glues.

7. The self-balancing floating battery case according to claim 1, wherein a cableway is provided beside the light opening in the upper casing, wherein the cableway corresponds to the PCB cavity, a PCT board is provided in the PCB cavity, a storage battery is provided in the battery cavity, a cable is introduced from the PCB board and the cable passes the cableway and is connected with at least one solar energy charger board.

8. The self-balancing floating battery case according to claim 1, wherein the at least one solar energy charger board are provided to be two.
